(19) United States
(12) Patent Application Publication
(10) Pub. No.: US 2016/0073184 A1
(43) Pub. Date: Mar. 10, 2016

(54) Audio Bicycle Steering Wheel Device

(71) Applicant: Kosta Popovski, Markham (CA)

(72) Inventor: Kosta Popovski, Markham (CA)

(21) Appl. No.: 14/482,370

(22) Filed: Sep. 10, 2014

(51) Int. Cl. H04R 1/02; B62K 23/02; B62J 6/02; B62K 21/12; B62J 99/00

(52) U.S. Cl. CPC H04R 1/028; B62K 21/12; B62J 99/00; B62J 6/02; B62K 23/02; H04R 2499/13; B62J 2099/0006; B62J 2099/004

(57) ABSTRACT

An audio bicycle steering wheel device facilitates listening to audio while riding a bicycle. The device includes a ring and a housing coupled to the ring. The housing is positioned in a center of the ring and extends across the center of the ring. A speaker and an audio player are coupled to the housing. The audio player is operationally coupled to the speaker to broadcast audio provided to the speaker by the audio player. A mounting bracket is coupled to a back face of the housing for coupling to a handlebar riser of a bicycle.

### BACKGROUND OF THE DISCLOSURE

### Field of the Disclosure

The disclosure relates to steering wheel devices and more particularly pertains to a new steering wheel device for facilitating listening to audio while riding a bicycle.

### SUMMARY OF THE DISCLOSURE

An embodiment of the disclosure meets the needs presented above by generally comprising a ring and a housing coupled to the ring. The housing is positioned in a center of the ring and extends across the center of the ring. A speaker and an audio player are coupled to the housing. The audio player is operationally coupled to the speaker to broadcast audio provided to the speaker by the audio player. A mounting bracket is coupled to a back face of the housing for coupling to a handlebar riser of a bicycle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side view of an audio bicycle steering wheel device according to an embodiment of the disclosure.

FIG. 2 is a front view of an embodiment of the disclosure.

FIG. 3 is a back view of an embodiment of the disclosure.

FIG. 4 is a side view of an embodiment of the disclosure in use.

FIG. 5 is a schematic view of an embodiment of the disclosure.

### DESCRIPTION OF THE PREFERRED EMBODIMENT

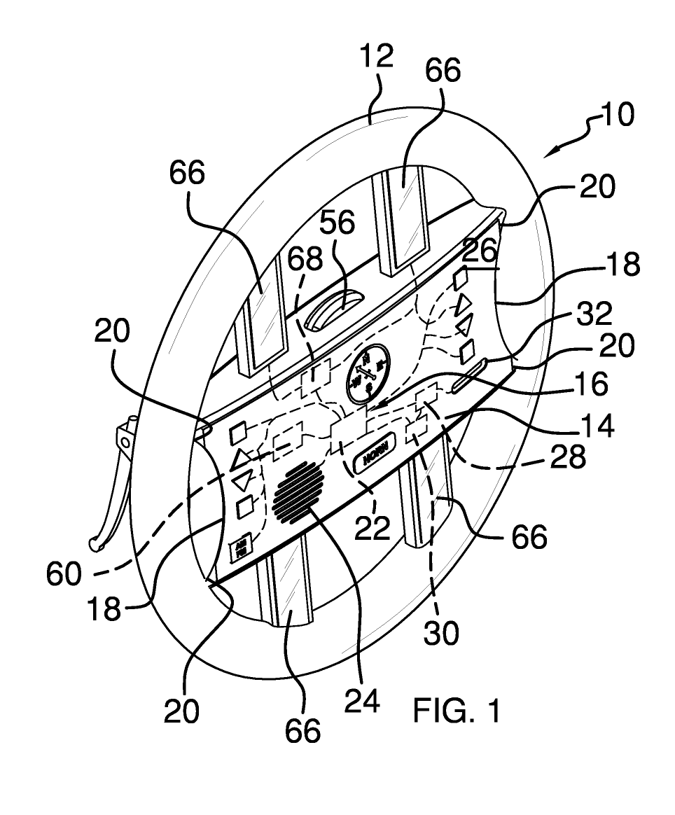

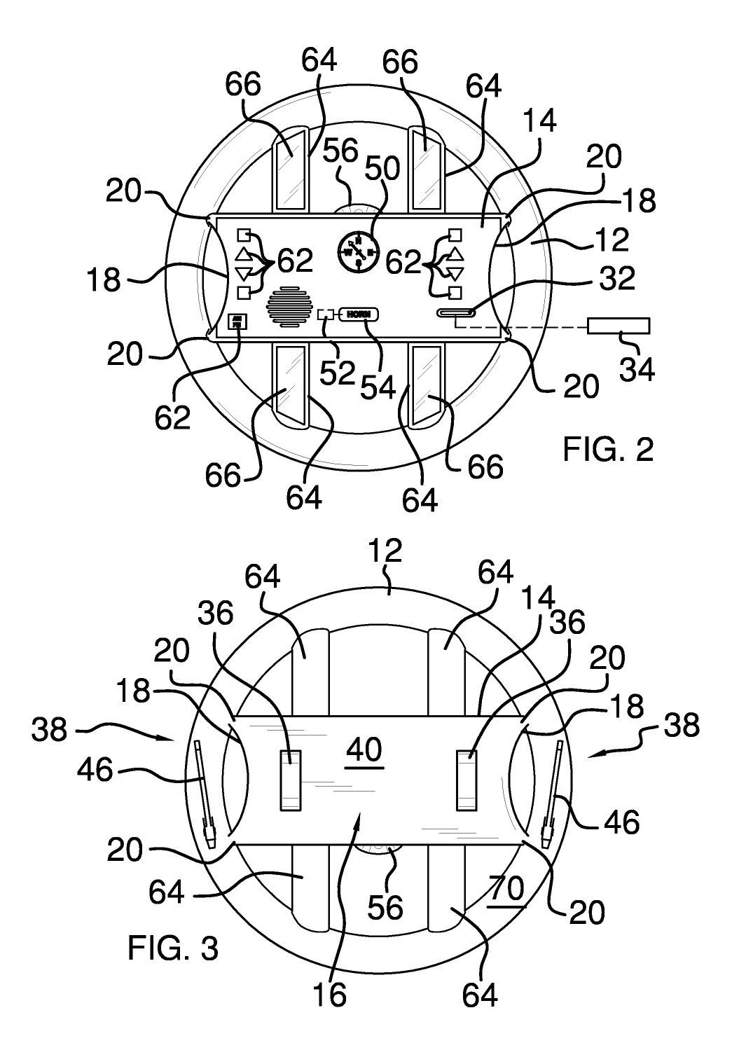

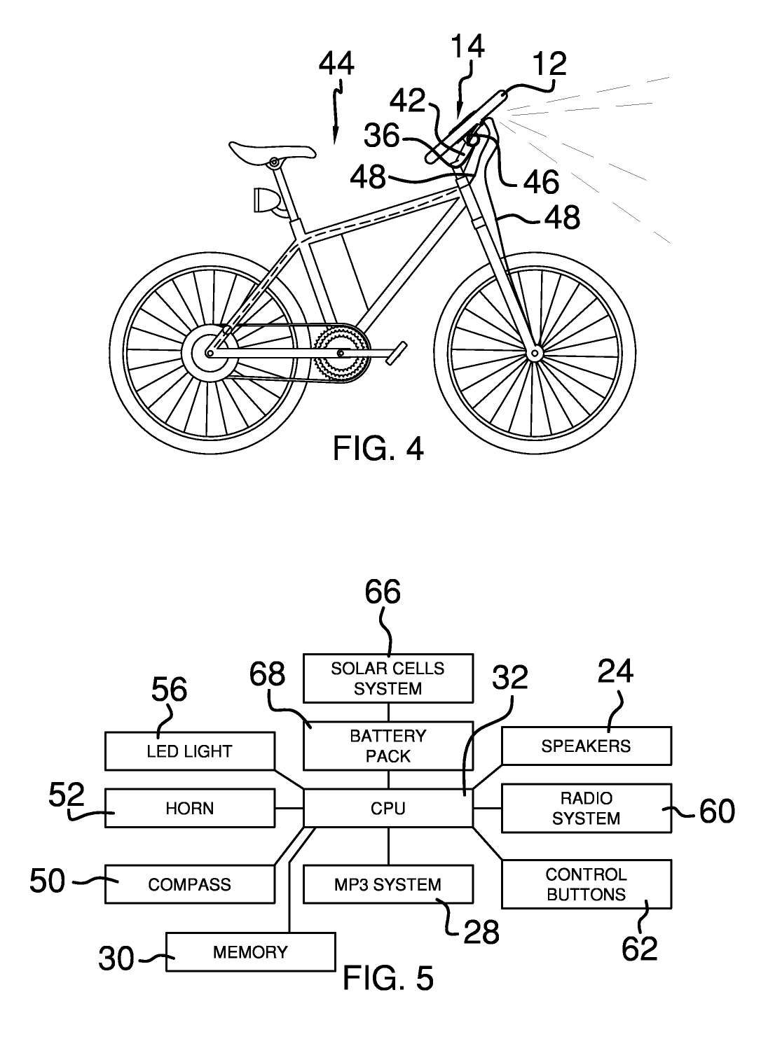

With reference now to the drawings, and in particular to FIGS. 1 through 5 thereof, a new steering wheel device embodying the principles and concepts of an embodiment of the disclosure and generally designated by the reference numeral 10 will be described.

As best illustrated in FIGS. 1 through 5, the audio bicycle steering wheel device 10 generally comprises a ring 12 and a housing 14 coupled to the ring 12. The housing 14 is positioned in a center 16 of the ring 12. The housing 14 has concave outer sides 18 and corners 20. Each of the corners 20 is coupled to the ring 12 such that the housing 14 extends across the center 16 of the ring 12. A processor 22 is coupled to and positioned in the housing 14. A speaker 24 is coupled to the housing 14 and positioned on a front face 26 of the housing 14 to direct sound away from the housing 14. The speaker 24 is operationally coupled to the processor 22. An audio player 28 is coupled to the housing 14. The audio player 28 may utilize digital files stored in memory 30 coupled to the housing 14 and accessible to the processor 22. The audio player 28 is operationally coupled to the speaker 24 and the processor 22 wherein the speaker 24 broadcasts audio provided to the speaker 24 by the audio player 28. An input slot 32 may be provided on front face 26 the housing 14 and communicatively coupled to the processor 22 wherein audio files on an extrinsic storage card 34 may be broadcast through the speaker 24 when the extrinsic storage card 34 is inserted into the input slot 32. A radio receiver 60 may also be coupled to the housing 14. The radio receiver 60 is operationally coupled to the processor 22 and the speaker 24 wherein the speaker 24 broadcasts audio from the radio receiver 60.

Each of a pair of spaced mounting brackets 36 is coupled to the housing 14 proximate a respective side 38 of the ring 12. Each mounting bracket 36 is coupled to a back face 40 of the housing 14 wherein the housing 14 is configured for coupling to a handlebar riser 42 of a bicycle 44. Each of a pair of brake levers 46 is coupled to the ring 12. Each brake lever 46 is positioned on the back face 40 of the ring 12. Each brake lever 46 is configured for coupling to a respective brake cable 48 of the bicycle 44. Each brake lever 46 is positioned on one of the respective sides 38 of the ring 12.

A number of additional functions may be provided including a compass 50 coupled to the housing 14 and positioned on the front face 26 so the compass 50 is visible to a rider of the bicycle 44. A horn 52 is coupled to the housing 14. The horn 52 may or may not be incorporated into the speaker 24. A horn button 54 is coupled to the housing 14 and positioned on the front face 26. The horn button 54 is operationally coupled to the horn 52 wherein the horn 52 is actuated by manipulation of the horn button 54. A light 56 is coupled to the housing 14. The light 56 is positioned on a top side 58 of the housing 14. The light 56 is directed away from the housing 14 such that the light 56 is configured to illuminate an area in front of the bicycle 44. A plurality of controls 62 is provided on the front face 26 of the housing 14. Each of the controls 62 is operationally coupled to the processor 22. The controls 62 are positioned proximate each of the concave outer sides 18 of the housing 14 to be readily accessible and manipulatable by a thumb while fingers are grasping the ring 12 for maintaining control of the ring 12. Each of the controls 62 controls a function of the audio player 28, radio receiver 60, light 56, or other functional aspects of the device 10. Thus, manipulation of the controls 62 allows for volume control, track selection, audio source selection, and the like in a conventional manner.

Each of a plurality of spokes 64 is coupled to and extends between the housing 14 and the ring 12. Each of a plurality of solar cells 66 is coupled to an associated one of the spokes 64. Each of the solar cells 66 is positioned on a front face 70 of the associated spoke 64. A battery 68 is coupled to the housing 14. Each of the solar cells 66 is electrically coupled to the battery 68 wherein the solar cells 66 charge the battery 68. The audio player 28, light 56, radio receiver 60, processor 22, horn 52, and any other electrically powered aspects of the device are electrically coupled to the battery such that each is electrically powered by the battery 68.

In use, the housing 14 is mounted to the handlebar riser 42, or the like, of the bicycle 44 coupling the ring 12 to the bicycle 44. Each brake lever 46 is coupled to the respective brake cable 48. Thus, the device 10 functionally replaces a conventional handlebar. The device 10 provides use of the audio player 28, light 56, radio receiver 60, and horn 52 as desired while riding the bicycle 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An audio bicycle steering wheel device comprising:
a ring;
a housing coupled to said ring, said housing being positioned in a center of said ring, said housing extending across said center of said ring;
a speaker coupled to said housing;
an audio player coupled to said housing, said audio player being operationally coupled to said speaker wherein said speaker broadcasts audio provided to said speaker by said audio player; and
a mounting bracket coupled to a back face of said housing wherein said housing is configured for coupling to a handlebar riser of a bicycle.

2. The device of claim 1, further comprising a compass coupled to said housing, said compass being positioned on a front face of said housing wherein said compass is configured to be visible to a rider of the bicycle.

3. The device of claim 1, further comprising:
a horn coupled to said housing; and
a horn button coupled to said housing, said horn button being operationally coupled to said horn wherein said horn is actuated by manipulation of said horn button.

4. The device of claim 1, further comprising said mounting bracket being one of a pair of spaced mounting brackets, each of said mounting brackets being coupled to said housing proximate a respective side of said ring.

5. The device of claim 1, further comprising a plurality of spokes coupled to and extending between said housing and said ring.

6. The device of claim 5, further comprising a plurality of solar cells, each of said solar cells being coupled to an associated one of said spokes.

7. The device of claim 6, further comprising each of said solar cells being positioned on a front face of said associated spoke.

8. The device of claim 1, further comprising a plurality of controls, each of said controls being operationally coupled to said audio player, each of said controls controlling a function of said audio player.

9. The device of claim 1, further comprising a light coupled to said housing, said light being positioned on a top side of said housing, said light being directed such that said light is configured to illuminate an area in front of the bicycle.

10. The device of claim 1, further comprising a brake lever, said brake lever being coupled to said ring, said brake lever being positioned on a back face of said ring, said brake lever being configured for coupling to a brake cable of the bicycle.

11. The device of claim 10, further comprising said brake lever being one of a pair of said brake levers, each brake lever being positioned on a respective side of said ring, each said brake lever being configured for coupling to a respective brake cable of the bicycle.

12. The device of claim 1, further comprising a radio receiver coupled to said housing, said radio receiver being operationally coupled to said speaker wherein said speaker broadcasts audio from said radio receiver.

13. The device of claim 6, further comprising a battery coupled to said housing, each of said solar cells being electrically coupled to said battery wherein said solar cells charge said battery, said audio player being electrically coupled to said battery wherein said audio player is electrically powered by said battery.

14. An audio bicycle steering wheel device comprising:
a ring;
a housing coupled to said ring, said housing being positioned in a center of said ring, said housing extending across said center of said ring;
a processor coupled to and positioned in said housing;
a speaker coupled to said housing, said speaker being operationally coupled to said processor;
an audio player coupled to said housing, said audio player being operationally coupled to said speaker and said processor wherein said speaker broadcasts audio provided to said speaker by said audio player;
a pair of spaced mounting brackets, each of said mounting brackets being coupled to said housing proximate a respective side of said ring, each mounting bracket being coupled to a back face of said housing wherein said housing is configured for coupling to a handlebar riser of a bicycle;
a compass coupled to said housing, said compass being positioned on a front face of said housing wherein said compass is configured to be visible to a rider of the bicycle.
a horn coupled to said housing;
a horn button coupled to said housing, said horn button being operationally coupled to said horn wherein said horn is actuated by manipulation of said horn button;
a plurality of spokes coupled to and extending between said housing and said ring;
a plurality of solar cells, each of said solar cells being coupled to an associated one of said spokes, each of said solar cells being positioned on a front face of said associated spoke;
a plurality of controls, each of said controls being operationally coupled to said processor, each of said controls controlling a function of said audio player;
a light coupled to said housing, said light being positioned on a top side of said housing, said light being directed such that said light is configured to illuminate an area in front of the bicycle;
a pair of brake levers, each said brake lever being coupled to said ring, each said brake lever being positioned on said back face of said ring, each said brake lever being configured for coupling to a respective brake cable of the bicycle, each brake lever being positioned on a respective side of said ring;
a radio receiver coupled to said housing, said radio receiver being operationally coupled to said processor and said speaker wherein said speaker broadcasts audio from said radio receiver; and
a battery coupled to said housing, each of said solar cells being electrically coupled to said battery wherein said solar cells charge said battery, said audio player being electrically coupled to said battery wherein said audio player is electrically powered by said battery.
